(19) United States
(12) Patent Application Publication
(10) Pub. No.: US 2002/0087520 A1
(43) Pub. Date: Jul. 4, 2002

(54) Appartus and method for connecting experts to topic areas

(76) Inventor: Paul Anthony Meyers, Granite Bay, CA (US)

Correspondence Address: HEWLETT-PACKARD COMPANY, Intellectual Property Administration, P.O. Box 272400, Fort Collins, CO, 80527-2400, US

(21) Appl. No.: 09/738,418

(22) Filed: Dec. 15, 2000

(51) Int. Cl. G06F 7/00

(52) U.S. Cl. 707/3

(57) ABSTRACT

An apparatus and method to connect experts to communications in topic areas of interest to the experts. One embodiment of the invention involves a method to connect an expert to a question or document in a topic area of interest to the expert. The method includes determining a topic area that the question or document could be classified under; searching an expert profile database to find a matching expert who would want to be notified about the question or document; and creating and sending or displaying a message to the matching expert concerning the question or document. A second embodiment of the invention involves a data processing system to connect an expert to a question or document in a topic area of interest to the expert. The data processing system includes an analyzer to determine a topic area that a question or document could be classified under; a searchable expert profile database containing information on matching experts who potentially want to be notified about the communication; and a message system for creating and sending or displaying a message to the matching expert concerning the question or document.

### BACKGROUND OF THE INVENTION

1. Field of the Invention

This invention relates generally to reducing the time for an expert to find a topic area of interest, and more specifically to precisely connecting experts to questions with topic areas the expert can answer, or information the expert wants to be notified about.

2. Description of the Prior Art

Computer software systems already exist to connect questioners to experts, in order to minimize the time spent in finding an appropriate expert. One such computer software system is TACIT, which makes searchable profiles of experts based on the email messages and documents written by the experts. In most systems, email is used to notify the expert that questions have been created. However, this type of computer software system has two deficiencies, the first deficiency is that an expert can quickly become overwhelmed by a large email, and the second deficiency is that the information might not be provided to the expert at a time when he is ready to process information.

Another type of computer software system, commonly known as a resume scanner, finds the most appropriate expert for an employer on the basis of the frequency of employer-chosen keywords found in computer scanned job applicant resumes. Yet another type of computer software system, commonly known as a browser, finds documents based on pre-selected keywords. However, none of these types of computer software systems are directed to minimizing the effort required by an expert to find questions he can answer, or directed to automatically find information of interest.

Other computer software systems on the Internet (e.g., ASKME.COM, and so forth) allow experts to search for questions and questioners to search for experts. However, these types of computer software systems require that all expertise be classified strictly within predefined categories. Such predefined categories may be far too broad and not accurately classify a narrow area of expertise of the expert. Furthermore, these types of computer software systems are directed to a question-based search system, and are not directed to a much wider area-of-interest search system that provides new information of interest to the expert.

It would be desirable to provide an expert with questions and documents in areas of interest to the expert, without requiring them to fit within predefined categories.

### SUMMARY OF THE INVENTION

The invention provides a system and method to provide an expert with questions and documents (e.g., video, audio, slides, spreadsheets, text files, and equivalents) in areas of interest to the expert, without requiring the questions to fit within predefined categories. The invention can be implemented in numerous ways, such as a method, a system, an apparatus, and a program on electronic-readable media. Two aspects of the invention are described below.

A first aspect of the invention is directed to a method to connect an expert to a question or document in a topic area the expert wants to be notified about. The method includes determining a topic area that a question or document could be classified under;

adding the question or document to a question or document database; searching a question or document database to find a matching question or document that matches a profile of the expert; informing the expert of the matching question or document for which the expert has demonstrated an interest; providing the question or document to the expert after the expert has demonstrated a willingness to receive the question or document.

A second aspect of the invention is directed to a data processing system to connect an expert to a question or document in a topic area the expert wants to be notified about. The data processing system includes an analyzer to determine a topic area that the question or document could be classified under; a question or document database to which to add the question or document, and in which to find a matching question or document that matches a profile of the expert; means for informing the expert of the matching question or document for which the expert has demonstrated an interest; and a message system to provide the question or document to the expert after the expert has demonstrated a willingness to receive the question or document.

These and other objects and advantages of the invention will become apparent to those skilled in the art from the following detailed description of the invention and the accompanying drawings.

### BRIEF DESCRIPTION OF THE DRAWINGS

FIG. 1 illustrates a block diagram of a computer software system, according to one preferred embodiment of the invention.

FIG. 2 illustrates an expanded data structure inside the expert profile database, according to one preferred embodiment of the invention.

FIG. 3 illustrates a flow chart of a method for using one embodiment of the invention.

FIG. 4 illustrates a more detailed flow chart of the method illustrated in FIG. 3 and shows how corresponding new questions or documents are entered in an unanswered question or document database in accordance with one embodiment of the invention.

FIG. 5 illustrates a more detailed flow chart of the method illustrated in FIG. 3 and shows how corresponding new questions or documents are entered in an expert profile database in accordance with one embodiment of the invention.

### DETAILED DESCRIPTION OF THE PREFERRED EMBODIMENTS

The invention provides a method and apparatus to provide the expert with questions and documents in areas of interest to the expert, without requiring the questions and documents to fit within predefined categories.

In the most preferred embodiment of the invention, the invention will determine the questions and other documents that will most likely be of interest to the expert. In another preferred embodiment of the invention, the invention will allow the expert to manually specify the questions and documents that the expert wants to receive. The interest areas and expertise areas of the expert are originally determined by initial communications from an expert to the invention. The most preferred embodiment of the invention updates the profile of an expert by analyzing the answers sent by the expert in response to questions. Alternative embodiments of the invention determine the profile of an expert based on submitted papers (e.g., essays, articles, books), recognition of voice inputs from the expert, or computer interface inputs by the expert or others.

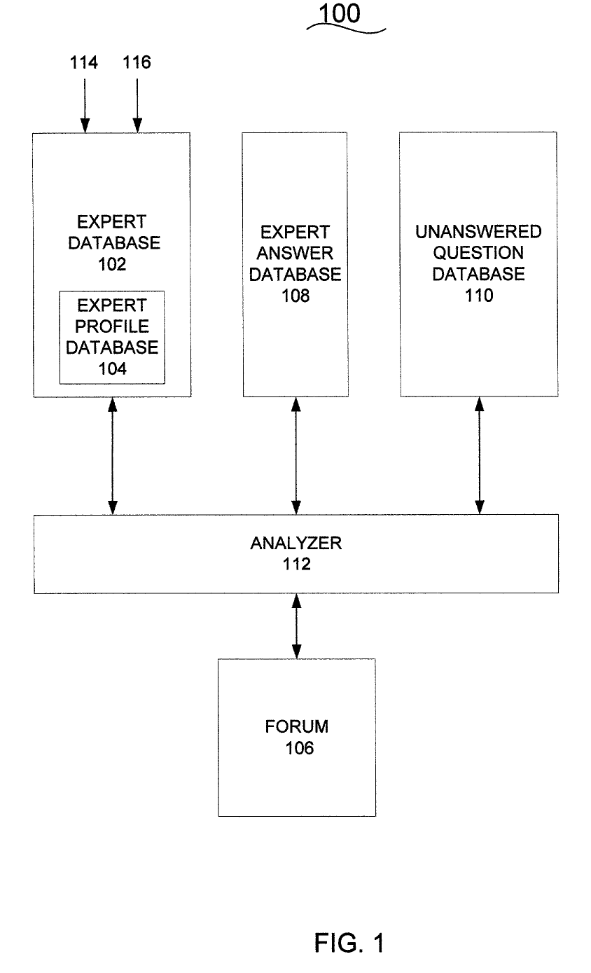

FIG. 1 illustrates a block diagram of a computer software system, according to one preferred embodiment of the invention. In one preferred embodiment, the system includes an expert database 102, which includes an expert profile database 104, a forum 106 (e.g., an Internet forum, such as an Hewlett-Packard Forum at the address http://forums.itrc.hp.com) for receiving questions for the experts, an expert answer database 108 for expert answers that will be provided to the forum 106, an unanswered question database 110, and an analyzer 112 which analyzes which questions and documents that the expert would most likely want to see. The analyzer 112 uses the expert answer database 108 to update the expert profile database 104. In one embodiment of the invention, the expert profile database 104 is also updated by direct input 114 from an expert. In another embodiment of the invention, the expert profile database 104 can also be updated by an input 116 from a person or entity besides the expert.

Most preferably, the analyzer 112 will use an existing software product to send an email message, or send another type of message (e.g., a voice message by telephone or computer, a facsimile, and equivalents) to the expert that informs the expert of the questions and documents most likely to be of interest to the expert. In preferred embodiments of the invention, the questions or documents will be ranked according to the estimated amount of interest to the expert. In preferred embodiments of the invention, the questions and documents will be grouped in subject areas of interest to the expert. Thus, the expert will be able to quickly select and prioritize the questions and documents he wants to see.

In more preferred embodiments of the invention, the message is only sent to the expert when he indicates his availability by an action or trigger (e.g., logging into the forum website on the Internet, activating an application on his system, sending an email message to a specific address on a computer system, making a telephone call, and so forth). Alternative preferred embodiments of the invention send a message to the expert whenever one question or one document is found that would be of high interest to the expert, regardless of whether he logged into the forum website or not. However, such embodiments would potentially subject the expert to an excessive and annoying number of messages. Most preferably, the expert is able to pre-select the number of questions and documents contained in the message, and is able to pre-select the frequency (e.g., every hour, once a day, once a week, and so forth), manner (email, voice, telephone, fax, and so forth), and circumstances (logged into the forum, not logged into the forum, picking up a telephone, or other conditions indicating availability) of the transmission of the messages to the expert.

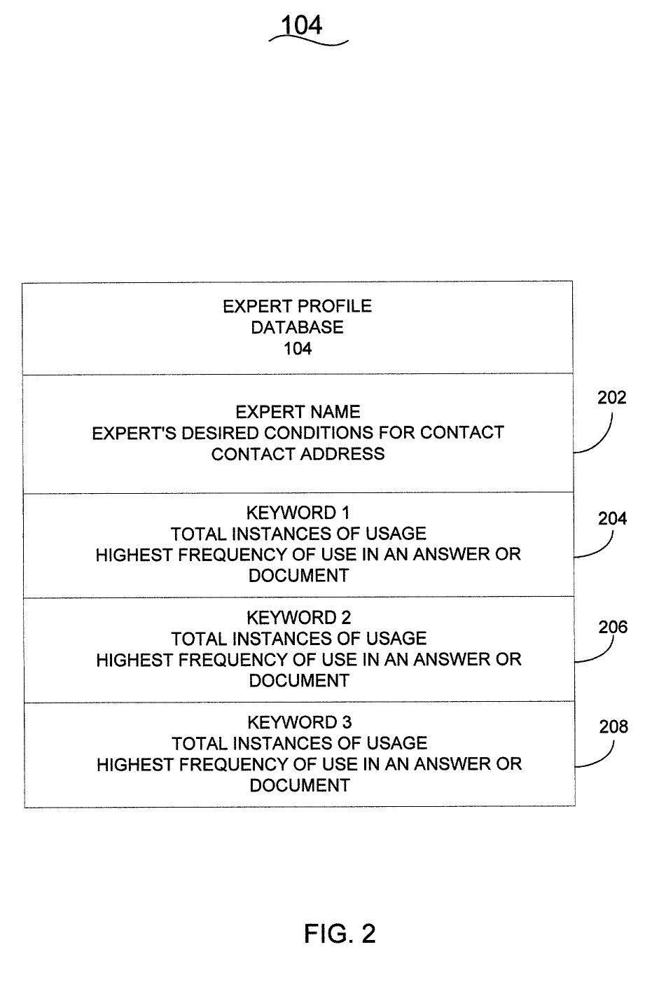

FIG. 2 illustrates an expanded data structure inside the expert profile database 104, according to one preferred embodiment of the invention. The expert profile database includes a section 202 containing the name, address, and contact information for an expert (in some embodiments this would include pre-defined rules for making expert contact), a section 204 for a first keyword that characterizes one interest of the expert, a section 206 for a second keyword that characterizes a second interest of the expert, and a section 208 for a third keyword that characterizes a third interest of the expert. In one more preferred embodiment, the expert profile database 104 or the expert database 102 (shown in FIG. 1) can also store messages for delivery to the expert upon occurrence of a trigger, discussed in more detail below.

In one preferred embodiment, every communication (e.g., document and question answer) sent by the expert is scanned once to identify keywords that are used to update the expert's profile. The data structure inside the expert profile database 104 is more preferably ordered for quick keyword matching by the analyzer, but alternative embodiments can be unordered. The data structure preferably includes statistical information on the use of the keyword by the expert. Keyword statistical information (e.g., frequency of use in one answer or in all answers, and so forth) increases the accurate targeting of a communication (e.g., question or document) to the most appropriate expert.

In the more preferred embodiments, the data structure inside the expert profile database can be easily updated with new keywords from the unanswered question database, the answer database, or new keywords received from the expert. These keywords would be added to the expert profile database whenever the analyzer has sufficient available time to update the expert profile database. In one preferred embodiment of the invention, the keywords are indexed in sparse tables with extra space for insertion of more keyword entries that will follow the index ordering system. In another preferred embodiment, the expert profile database in a non-volatile memory (e.g., magnetic disk memory, flash memory, and equivalents) is transferred to random access memory (RAM) to make updates to the expert profile database. Periodic keyword addition/subtraction and keyword re-indexing can be performed in RAM. The updated expert profile database is then transferred back to the non-volatile memory.

In the more preferred embodiments, the expert database can be easily updated (to add a new expert or to delete a current expert) based on a specific communication sent by the expert, updated by a third party with authority to add or delete experts to the expert database, and/or updated by the analyzer based on a forum communication from the expert. In one preferred embodiment of the invention, the experts are indexed in sparse tables with extra space for insertion of new experts. The ordering system of the experts can be arranged alphabetically on the surnames or chosen names of the experts, arranged according to a primary classification of expertise, arranged according to levels of accumulated characterization of expertise, or arranged by some other criteria (e.g., seniority of database listing, breadth of expertise, geographic location, availability, reliability, cost, and so forth).

The unanswered question database and the answer database are also updated by one of the methods described above. The analyzer can perform these updates, or dedicated processors can be assigned to update the databases. Alternative embodiments of the invention can use alternative schemes to update the databases, either updating all of the databases at the same time (e.g., at night), updating them at different times, or updating them constantly in the background with time slices dedicated for updating functions.

In one preferred embodiment, the unanswered questions, answered questions, and documents are stored in one communication database. This would be preferable if the experts potentially want to be informed of interesting answers to questions in particular topic areas. In another preferred embodiment, the unanswered questions and documents are stored in a communication database, and the answered questions and documents indicating topics of expertise are either stored in a separate database, or only scanned for keywords to potentially update the expert profile database and not stored in database memory order to reduce the amount of memory needed to implement the expert profile database.

In one preferred embodiment, the questions and documents are stored in the databases. In another preferred embodiment, the keywords and addresses of the questions and documents are stored in the databases, and the actual questions and documents are stored in another database. This embodiment allows the use of faster access memory (e.g., registers or RAM) to be used for searching the stored keywords, and the use of slower access memory (e.g., main memory, magnetic memory, optical memory) for the storage and retrieval of the actual questions or documents.

In one preferred embodiment, a central processing unit (CPU) reads the database information, performs any appropriate actions, and transfers the information to an appropriate destination, such as a disk memory, a printer for print out, or some other kind of peripheral device. The CPU clears entries from the databases when the entry information is no longer needed or useful (e.g., when a question has been answered, when an expert is no longer available, and so forth).

In another preferred embodiment, a dedicated processing unit reads the database information, performs any appropriate actions, and transfers the information to an appropriate destination. The dedicated processing unit clears entries from the databases when the entry information is no longer needed or useful.

In yet another preferred embodiment, the invention can be implemented by splitting the work between a CPU and a dedicated processor. For example, a microprocessor could maintain and search the databases, while a CPU performs all the other actions.

In order to simplify the discussion and facilitate an understanding of the invention, the following flowcharts concern an embodiment of the invention with only three experts A, B, and C. A flow chart of an alternative embodiment of the invention for more than three experts can be created by simple modification of following flow charts.

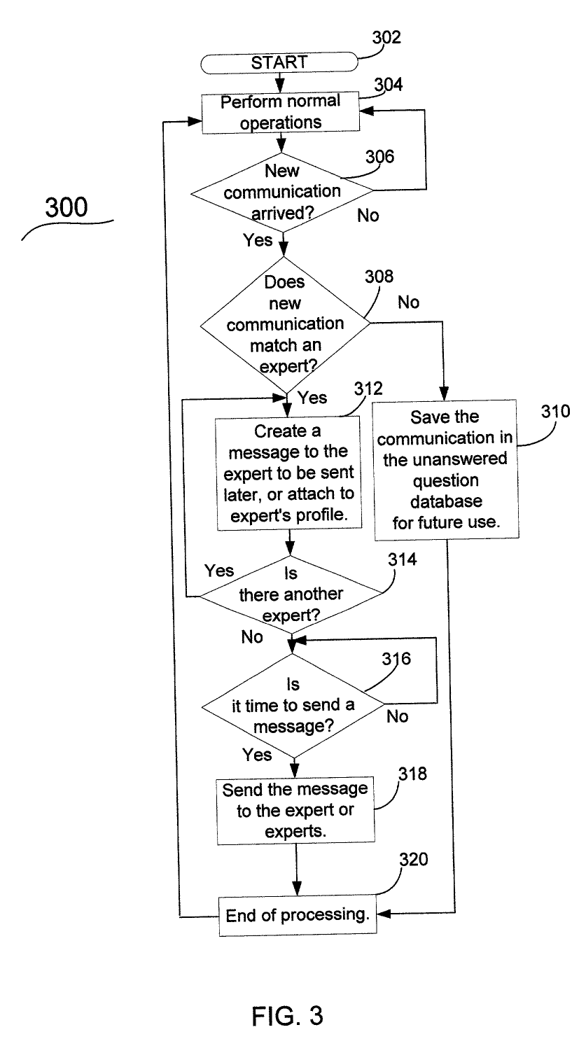

FIG. 3 illustrates a flow chart 300 of a method for identifying questions of interest to an expert in accordance with one embodiment of the invention. The method starts in operation 302. In operation 304, the data processing system performs normal data processing system processing tasks with a possibility of needing to update the communication (e.g., unanswered questions, documents, or answered questions) database, expert profile database, and so forth. In operation 306, a test is made to determine if a communication (e.g., an unanswered question, document, or answered question) has been added to the databases. If no new communication has occurred, then operation 304 is next. If a new communication has occurred, then operation 308 is next, where a test is made to determine if this new communication would match the areas of interest of any expert A, B, or C in the expert database. If there is no match, then operation 310 is next, where the communication is saved in the unanswered question database for future reference and operation 320 is next. If this new communication matches an expert profile, then operation 312 is next, where the new communication is added to a message that will be sent to the expert A, B, or C at the next appropriate time (e.g., by periodic schedule, or when the expert has indicated his availability, such as by entering a specific Internet forum). Alternatively in operation 312, the message is attached to the expert's profile, and displayed to the expert upon occurrence of a trigger (e.g., connection to a forum by the expert, an email message sent from the expert, a timer, or some equivalent trigger). This allows more flexibility in notifying the expert. In some systems, the notification occurs by email, notification occurs by a wireless application protocol (WAP) sending the message to a wireless device like a phone or a personal digital assistant (PDA), or notification occurs when the expert connects (e.g., via the Internet) to the system. Operation 314 is next, where a test is made to find any other interested expert. If there is another interested expert, operation 312 is repeated, where a message the new communication is created for sending to the next expert. If there are no more experts that would be interested in the new communication, then operation 316 is next, where there is a test to determine if it is appropriate to send the message(s) with news of the new communication to the expert(s). Operation 318 is next, where the message is sent. Operation 320 is next, where the message processing is finished, and operation 304 is next, where the data processing system resumes performance of normal operations until the next new communication is added to the databases.

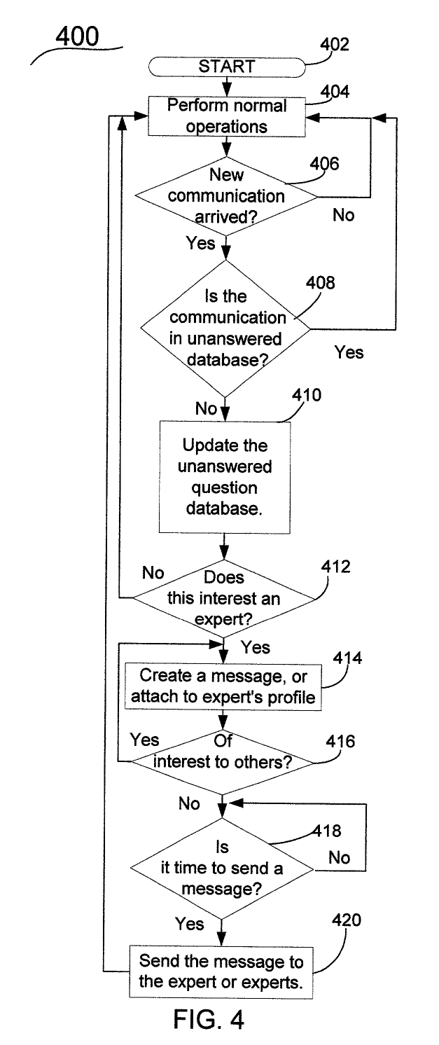

FIG. 4 illustrates a more detailed flow chart 400 of the method illustrated in FIG. 3 and shows how corresponding new communications are entered in an unanswered question or document database in accordance with one embodiment of the invention. The method starts in operation 402. In operation 404, the data processing system performs normal operations. Operation 406 is next, where it tests for a new communication (e.g., a question or document) received by the data processing system. Operation 408 is next, where a test is made to determine if the communication has been previously added to the unanswered question database. If it was previously added to the unanswered question database, then operation 404 is repeated. If a new communication has occurred, then operation 410 is next. In operation 410, the data processing system performs an update to the unanswered question database. Then operation 412 is next, where a test is made to determine if this new communication would match the areas of interest of any expert A, B, or C in the expert database. If this new communication matches an expert profile, then in operation 414 the new communication is added to a message that will be sent to the expert at the next appropriate time (e.g., by periodic schedule or when the expert has entered a certain forum). Alternatively in operation 414, the message is attached to the expert's profile, and displayed to the expert upon occurrence of a trigger (e.g., connection to a forum by the expert, an email message sent from the expert, a timer, or some equivalent trigger). Operation 416 is next, where a test is made to match the question or document to another expert profile, indicating that the expert might be interested in the unanswered question or document. If there is another expert, operation 414 is repeated, where the new communication is added to a message to another expert. If there are no more experts that would be interested in the new communication, then operation 418 is next, where there is a test to determine if it is appropriate to send the message(s) with news of the new communication to the appropriate expert(s). If the test of operation 418 determines it is not appropriate, the data processing system repeats operation 418. If the test of operation 418 determines it is appropriate, then operation 420 is next, where the message is sent to the experts. Then the data processing system repeats operation 404 and resumes performance of normal operations until the next new communication is added to the unanswered question database.

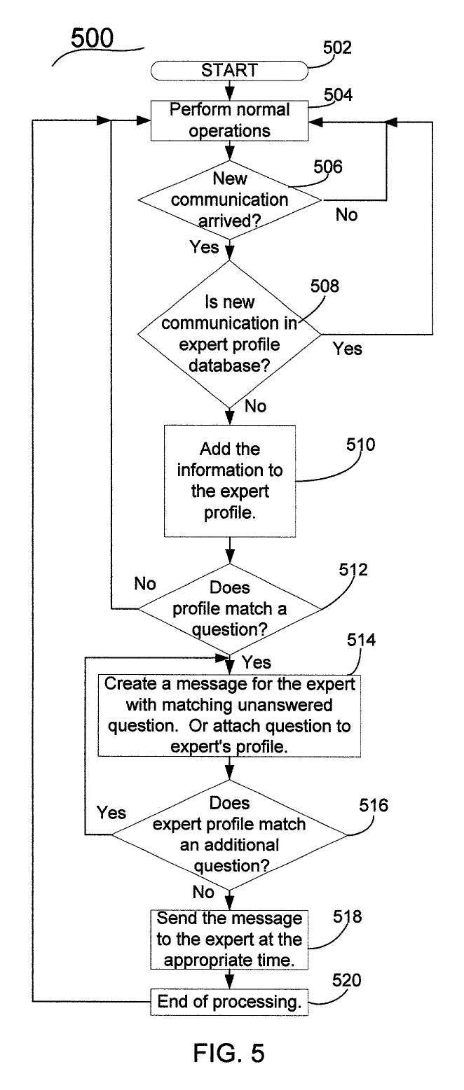

FIG. 5 illustrates a more detailed flow chart 500 of the method illustrated in FIG. 3 and shows how corresponding new questions or documents are entered in an expert profile database in accordance with one embodiment of the invention. The method starts in operation 502. In operation 504, the data processing system performs normal operations. In operation 506, a new communication (e.g., an answered question from an expert or document) is signaled to the data processing system, and then operation 508 is next. In operation 508, a test is made to determine if the answered question or document has been previously added to the expert profile database of A, B, and C. If the test determines the communication is already in the profile information for A, B, or C, then operation 504 is repeated. If new expert profile information has been received, then operation 510 is next. In operation 510, the data processing system performs an update to the expert profile database for A, B, or C. Then operation 512 is next, where a test is made to determine if this new communication to an expert profile would match any unanswered question in the unanswered question database. If this new communication matches an unanswered question, then operation 514 is next, where the unanswered question is added to a message that will be sent to the expert at the next appropriate time (e.g., by periodic schedule or when the expert has entered a certain forum). Alternatively in operation 514, the message is attached to the expert's profile, and displayed to the expert upon occurrence of a trigger (e.g., connection to a forum by the expert, an email message sent from the expert, a timer, or some equivalent trigger). This allows more flexibility for notification to occur by email, a wireless application protocol (WAP) sending the message to a wireless device like a phone or a personal digital assistant (PDA), or when the expert connects (e.g., via the Internet) to the system. Operation 516 is next, where a test is made to find additional unanswered questions that the expert might be able to answer or be interested in. If there is another unanswered question, operation 514 is repeated as necessary, where the other matching unanswered question is added to the message that will be sent to the expert at the next appropriate time. If the test of operation 516 determines that there are no more matching unanswered questions, then operation 518 is next, where the message with news of the matching unanswered question(s) is sent to the appropriate expert at the appropriate time. Then operation 520 is next, where the processing of this new information is finished. Then the data processing system repeats operation 504 and resumes performance of normal operations until the next new communication is received for possible addition to the expert profile database.

The exemplary embodiments described herein are for purposes of-illustration and are not intended to be limiting. Therefore, those skilled in the art will recognize that other embodiments could be practiced without departing from the scope and spirit of the claims set forth below.

What is claimed is:

1. A method to connect an expert to a question or document in a topic area said expert wants to be notified about, comprising:
determining a topic area that a question or document could be classified under;
adding said question or document to a question or document database;
searching a question or document database to find a matching question or document that matches a profile of said expert;
informing said expert of said matching question or document for which said expert has demonstrated an interest;
providing said question or document to said expert after said expert has demonstrated a willingness to receive said question or document.

2. The method of claim 1, wherein said step of determining a topic area includes identifying one or more keywords in said question or document.

3. The method of claim 2, wherein said step of searching a question or document database includes using said one or more keywords.

4. The method of claim 1, wherein said step of informing said expert of said matching question or document includes combining a plurality of messages into one message to be sent to said matching expert.

5. The method of claim 1, wherein informing said expert of said matching question or document for which said expert has demonstrated an interest occurs on an expert bulletin board system.

6. The method of claim 1, wherein said document is chosen from a group consisting of: a video file, an audio file, a slide file, a spreadsheet file, or a text file.

7. The method of claim 1, wherein informing said expert of said matching question or document for which said expert has demonstrated an interest is performed on a periodic basis specified by said matching expert.

8. The method of claim 1, further comprising:
receiving a response from said matching expert; and
removing said question or document from said question or document database.

9. The method of claim 1, further comprising:
updating an expert profile database regarding said matching expert according to a response from said matching expert.

10. A data processing system to connect an expert to a question or document in a topic area said expert wants to be notified about, comprising:
an analyzer to determine a topic area that said question or document could be classified under;
a question or document database to which to add said question or document, and in which to find a matching question or document that matches a profile of said expert;
means for informing said expert of said matching question or document for which said expert has demonstrated an interest;
a message system to provide said question or document to said expert after said expert has demonstrated a willingness to receive said question or document.

11. The data processing system of claim 10, wherein said analyzer to determine a topic area can identify one or more keywords in said communication.

12. The data processing system of claim 11, wherein said a question or document database can be searched by using one or more keywords.

13. The data processing system of claim 10, wherein said means for informing said matching expert can combine a plurality of messages into one message to be sent to said matching expert.

14. The data processing system of claim 10, wherein said means for informing said matching expert, and said message system to provide said question or document to said matching expert use an expert bulletin board system.

15. The data processing system of claim 10, wherein said document can be a file chosen from the group consisting of: a video file, an audio file, a slide file, a spreadsheet file, or a text file.

16. The data processing system of claim 10, wherein said means for informing said expert of said matching question or document operates on a periodic basis specified by said matching expert.

17. The data processing system of claim 10, further comprising:
means for receiving a response from said matching expert; and
means for removing said question or document from said question or document database.

18. The data processing system of claim 10, further comprising:
means for updating said expert profile database regarding said matching expert according to said response from said matching expert.

19. A computer program embodied on an electronically readable media, containing instructions to connect an expert to a communication in a topic area said expert wants to be notified about, comprising:
an instruction segment to determine a topic area that a communication could be classified under;
an instruction segment to add said communication to a communication database;
an instruction segment to search an expert profile database to find a matching expert who would want to be notified about said communication;
an instruction segment to compose a message to said matching expert to inform said matching expert of said communication; and
an instruction segment to send said message to said matching expert at a time acceptable to said matching expert.

20. The computer program of claim 19, further comprising:
an instruction segment to receive a response to said communication from said matching expert,
an instruction segment to remove said communication from said communication database; and
an instruction segment to update said expert profile database regarding said matching expert according to said response to said communication.
